(19) United States
(12) Patent Application Publication
(10) Pub. No.: US 2026/0238918 A1
(43) Pub. Date: Aug. 13, 2026

(54) OUTSIDE-VEHICLE SOUND PICKUP DEVICE, VEHICLE INCLUDING OUTSIDE-VEHICLE SOUND PICKUP DEVICE, AND OUTSIDE-VEHICLE SOUND DETECTION METHOD

(71) Applicant: Panasonic Automotive Systems Co., Ltd., Kanagawa (JP)

(72) Inventors: Yuichi ISHIKAWA, Hyogo (JP); Shuji AKAMATSU, Kanagawa (JP); Shunsuke TSUJIOKA, Osaka (JP); Yunyun CAO, Tokyo (JP); Osamu SHIBATA, Hyogo (JP)

(73) Assignee: Panasonic Automotive Systems Co., Ltd., Kanagawa (JP)

(21) Appl. No.: 19/534,198

(22) Filed: Feb. 9, 2026

(30) Foreign Application Priority Data
Feb. 10, 2025 (JP) 2025-020019

(51) Int. Cl. H04R 1/28; B60R 11/02; H04R 1/08; H04R 1/22; B60R 11/00

(52) U.S. Cl. CPC H04R 1/2876; B60R 11/0247; H04R 1/08; H04R 1/222; B60R 2011/0026; H04R 2201/003

(57) ABSTRACT

An outside-vehicle sound pickup device that reduces the influence of in-vehicle sound to pick up an outside-vehicle sound is provided. The outside-vehicle sound pickup device includes: a sound pickup device; and a sound insulating material shaped to have a space in which the sound pickup device is installed, in which the sound insulating material has an opening portion that is closed by a vehicle component.

### TECHNICAL FIELD

The present disclosure relates to an outside-vehicle sound pickup device, a vehicle including an outside-vehicle sound pickup device, and an outside-vehicle sound detection method.

### BACKGROUND ART

In recent years, with the spread of electric vehicles (EVs) that are being made quieter, there is a concern that outside-vehicle sound may not reach a driver, and a technology for allowing the driver to understand the surrounding sound without opening a window has been studied. For example, there is a demand for recognizing external sound according to a traveling environment such as a parking lot, a residential area, or a general road, and there is also a demand for a technology of picking up specific sound such as an approaching emergency vehicle, a crossing gate warning sound, an approaching vehicle sound, a bicycle bell sound, or a person's living sound from the viewpoint of improving safety.

As the related art, a method of picking up an outside-vehicle sound using a microphone installed outside a vehicle and transmitting the outside-vehicle sound to a driver is known (Patent Literatures (hereinafter, referred to as “PTLs”) 1 and 2). In addition, a technology of removing noise from the picked-up sound (PTL 3) has also been proposed.

### CITAATION LIST

### Patent Literature

### PTL 1

Japanese Patent Application Laid-Open No. 2011-242343

### PTL 2

Japanese Patent Application Laid-Open No. H8-2339

### PTL 3

Japanese Patent Application Laid-Open No. H6-219227

### SUMMARY OF INVENTION

### Technical Problem

However, in the existing outside-vehicle sound pickup technology, a microphone installed outside the vehicle is used, and the design may be complicated and the cost may increase due to wind noise countermeasures and waterproofing. In addition, the pickup of the outside-vehicle sound may be hindered by the in-vehicle sound, and it is difficult to acquire appropriate external sound information.

The present disclosure contributes to providing an outside-vehicle sound pickup device that reduces the influence of in-vehicle sound to pick up an outside-vehicle sound.

### Solution to Problem

An outside-vehicle sound pickup device according to the present disclosure includes: a sound pickup device; and a sound insulating material shaped to have a space in which the sound pickup device is installed, in which the sound insulating material has an opening portion that is closed by a vehicle component.

### ADVANTAGEOUS EFFECTS OF INVENTION

According to the present disclosure, it is possible to reduce the influence of in-vehicle sound to pick up an outside-vehicle sound.

### BRIEF DESCRIPTION OF DRAWINGS

FIG. 1 is a diagram showing a position at which an outside-vehicle sound pickup device according to Embodiment 1 is provided;

FIG. 2A is a plan view of the outside-vehicle sound pickup device according to Embodiment 1;

FIG. 2B is a cross-sectional view of the outside-vehicle sound pickup device according to Embodiment 1;

FIG. 2C is a cross-sectional view of a variation of the outside-vehicle sound pickup device according to Embodiment 1;

FIG. 3 is a cross-sectional view of an outside-vehicle sound pickup device according to Embodiment 2;

FIG. 4 is a cross-sectional view of an outside-vehicle sound pickup device according to Embodiment 3;

FIG. 5 is a diagram showing a configuration for obtaining an outside-vehicle sound audibility index; and

FIG. 6 is a plot diagram showing an outside-vehicle sound audibility index.

### DESCRIPTION OF EMBODIMENTS

### Embodiment 1

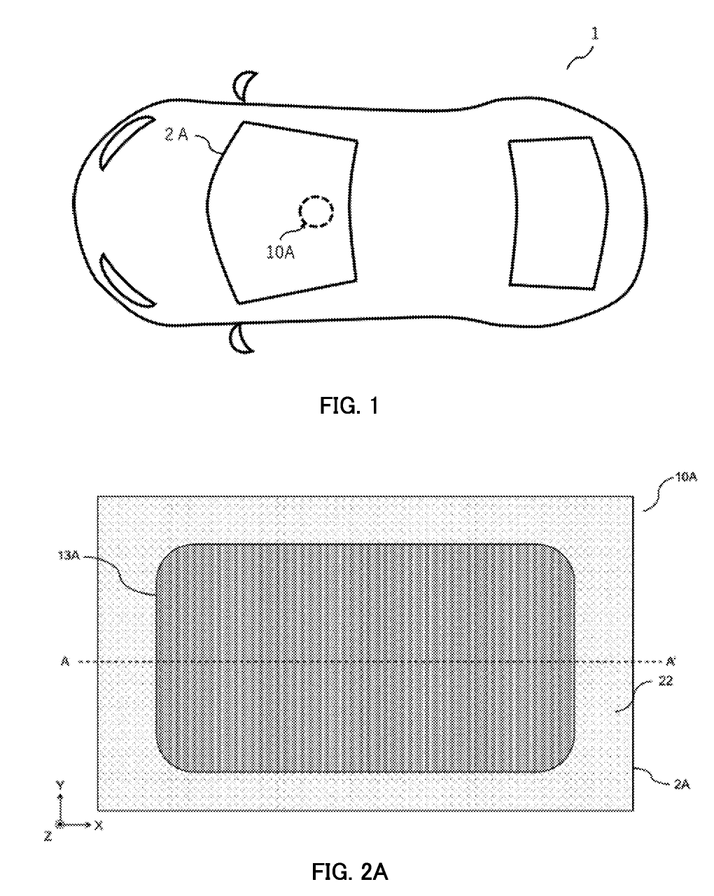

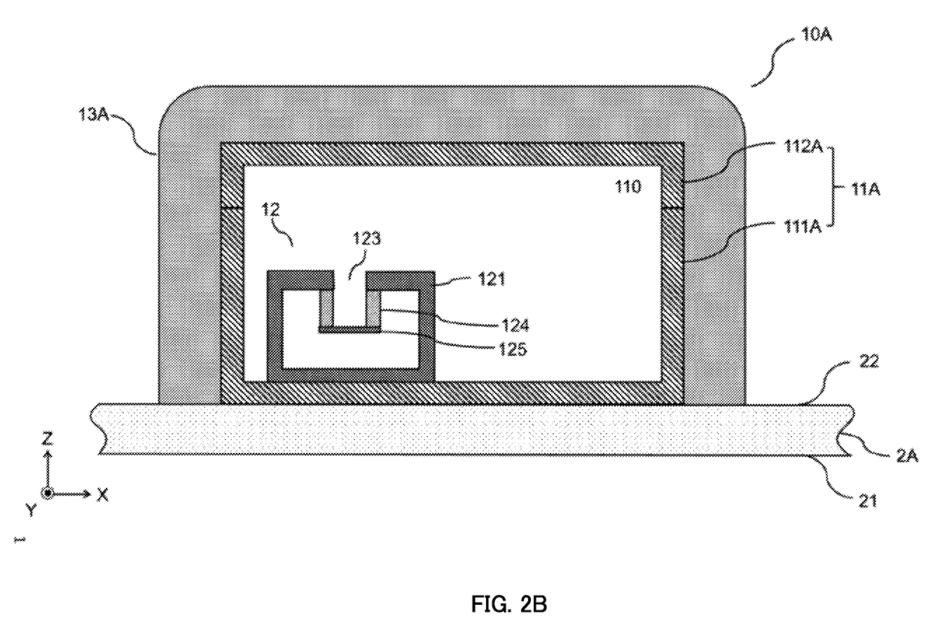

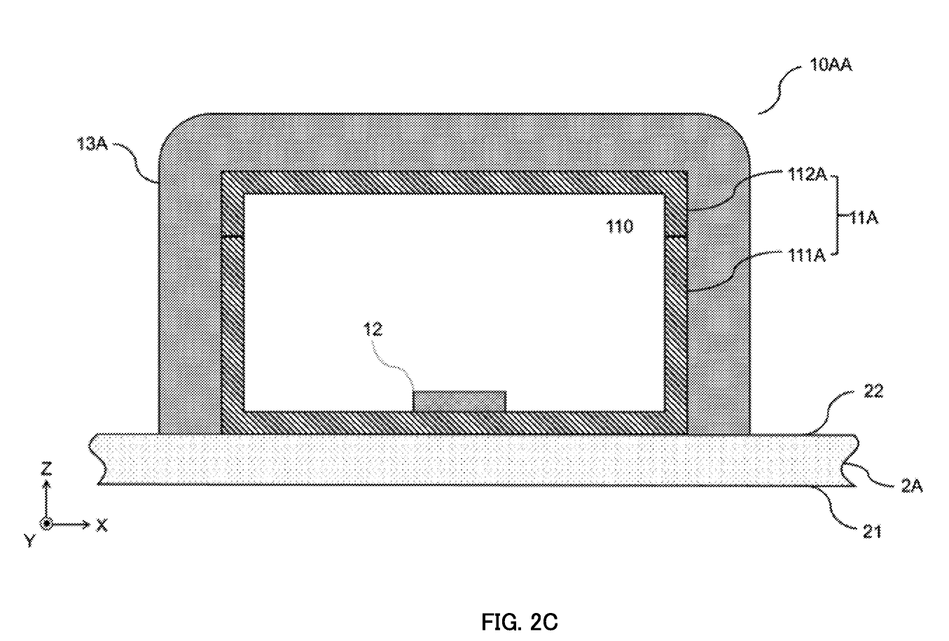

Outside-vehicle sound pickup device 10A according to Embodiment 1 will be described with reference to FIGS. 1, 2A, and 2B. FIG. 1 is a diagram showing a position at which outside-vehicle sound pickup device 10A according to Embodiment 1 is provided. FIG. 2A is a plan view of outside-vehicle sound pickup device 10A according to Embodiment 1. FIG. 2B is a cross-sectional view of outside-vehicle sound pickup device 10A according to Embodiment 1. Outside-vehicle sound pickup device 10A according to Embodiment 1 is mounted on the interior side of a windshield that is vehicle component 2A of vehicle 1, and is configured to pick up an outside-vehicle sound emitted outside vehicle 1 by capturing sound (vibration) transmitted to the windshield that is vehicle component 2A.

### Vehicle 1

The term "vehicle 1" refers to a device or a structure that is designed to transport a person, cargo, or supplies and that moves on the ground using wheels. Examples of vehicle 1 include a passenger car illustrated in FIG. 1, a commercial vehicle (truck, van, taxi, or the like), a vehicle for public transportation (bus or the like), a construction machine (bulldozer, shovel car, or the like), an agricultural vehicle (tractor or the like), an electric vehicle (electric vehicle (EV), plug-in hybrid vehicle (PHEV), fuel cell vehicle (FCV), or the like), a special vehicle (ambulance, fire engine, patrol car, or the like), and an autonomous driving vehicle (unmanned vehicle or the like), but the examples are not limited thereto.

### Vehicle Component 2A

The term "vehicle component 2A" refers to various components, devices, and the like that are mounted in the interior or on the exterior of the vehicle 1 and that contribute to functions of the vehicle such as traveling, safety, comfort, and information provision. Examples of vehicle component 2A include a windshield illustrated in FIG. 1, a body of vehicle 1, a front bumper, a rear bumper, a headlight cover, a fog lamp cover, a taillight cover, a door mirror cover, a side mirror cover, a rear windshield, an electronic mirror housing, a full-circumference camera housing, a drive recorder mount, and a drive recorder housing, but the examples are not limited thereto.

As illustrated in FIGS. 2A and 2B, vehicle component 2A has outer surface 21 and inner surface 22. In a case where vehicle component 2A is the windshield of vehicle 1 illustrated in FIG. 1, outer surface 21 is exposed to an outside-vehicle space, and inner surface 22 is exposed to an in-vehicle space. Here, the "outside-vehicle space" refers to an outside-vehicle space of vehicle 1, and refers to a region located outside an outer surface of vehicle 1 such as a vehicle body outer wall or glass. The outside-vehicle space includes a region that is directly exposed to an external environment such as wind and rain, dust, light, and sound during traveling of the vehicle. The "in-vehicle space" refers to an interior space of vehicle 1, and refers to a region in which a passenger sits or an item is accommodated in a cabin of vehicle 1. The vehicle interior is a region that is not directly exposed to an external environment such as wind and rain, dust, light, and sound during traveling of the vehicle.

For example, in a case where vehicle component 2A is the windshield as an exterior product, outer surface 21 is directly exposed to the outside-vehicle space and is a surface that is exposed to an external environment such as wind and rain, dust, flying objects, and sunlight during traveling, and inner surface 22 is exposed to the in-vehicle space of vehicle 1 and faces a driver and a passenger. In this case, sound waves generated in the outside-vehicle space are transmitted as vibrations to outer surface 21 of vehicle component 2A that is the windshield, and sound waves generated in the in-vehicle space are transmitted as vibrations to inner surface 22.

The "outside-vehicle sound" refers to a sound generated in the outside-vehicle space of vehicle 1. Examples of the outside-vehicle sound include a sound from a road surface during traveling, an approaching sound of another vehicle, a siren sound of an emergency vehicle, wind noise, a collision sound of raindrops, and noise or a warning sound generated in a surrounding environment, but the examples are not limited thereto.

The "in-vehicle sound" refers to a sound generated in the interior space of vehicle 1. Examples of the in-vehicle sound include a voice of a passenger, a sound of an audio system, an operation sound of an air conditioning system, a vibration sound or an operation sound of a device generated inside the vehicle, but the examples are not limited thereto.

In a case where vehicle component 2A is the front bumper as an exterior product, the sound transmitted to outer surface 21 and inner surface 22 is mainly the outside-vehicle sound that is an environmental sound outside the vehicle, while the transmission of the in-vehicle sound is an indirect sound through the vehicle structure.

On the other hand, in a case where vehicle component 2A is an interior product, both outer surface 21 and inner surface 22 are exposed to the in-vehicle space, and outer surface 21 is directed to the outside-vehicle direction though it is located in the in-vehicle space. For example, in a case where vehicle component 2A is a housing of a drive recorder installed on the interior side of the windshield, outer surface 21 is disposed in the in-vehicle space, and a part of the housing of the drive recorder is in contact with the windshield that is in contact with the outside-vehicle space. In such a case, both outer surface 21 and inner surface 22 of the drive recorder are located in the in-vehicle space, but since a part of outer surface 21 is in contact with the windshield, the in-vehicle sound is transmitted, while the outside-vehicle sound can be transmitted to outer surface 21. Even in a case where a part of the housing of the drive recorder is not directly in contact with the windshield, outside-vehicle sound pickup device 10A may be configured to be separated from the drive recorder and installed on the windshield.

### Outside-vehicle Sound Pickup Device 10A

Outside-vehicle sound pickup device 10A includes sound pickup device 12 that is provided in housing 11A fixed to inner surface 22 of vehicle component 2A and that picks up an outside-vehicle sound, and sound insulating material 13A that surrounds housing 11A. In FIGS. 2A and 2B, housing 11A and sound insulating material 13A are illustrated as being separate from each other, but housing 11A and sound insulating material 13A may be integrally formed with each other. In addition, outside-vehicle sound pickup device 10A may be a vibration sensor that detects vibration of vehicle component 2A.

In a case where vehicle component 2A is the windshield, outside-vehicle sound pickup device 10A is provided on inner surface 22 that is a surface of the windshield facing the vehicle cabin. In a case where vehicle component 2A is the body of vehicle 1, outside-vehicle sound pickup device 10A is provided on inner surface 22 that is a back surface of the body. In a case where vehicle component 2A is the front bumper or the rear bumper of vehicle 1, outside-vehicle sound pickup device 10A is provided on inner surface 22 that is a back surface of the bumper.

### Housing 11A

Housing 11A is fixed to vehicle component 2A. Housing 11A of Embodiment 1 is formed as a separate member from vehicle component 2A. The “separate member” refers to a structure that can be fixed as an add-on to vehicle component 2A at the time of attachment. With this structure, housing 11A can be easily replaced or repaired, and can flexibly respond to a specification change or an application of vehicle component 2A.

Housing 11A is a body (case) or a structure for accommodating and protecting the sound pickup device and a wiring line connected to the sound pickup device, and a space called cavity 110 is provided inside housing 11A. The term "cavity 110" refers to a hollow portion formed in housing 11A, and functions as a place where the outside-vehicle sound or the in-vehicle sound propagates and also functions as a space that provides a place where air vibrates due to vibration of housing 11A itself in cavity 110.

An example of the fixation of housing 11A and vehicle component 2A is adhesive fixation using a double-sided tape, an epoxy resin, or a silicone-based adhesive, mechanical fixation using a bolt, a nut, a clip, a rivet, or the like, magnetic fixation using a magnet, or press-fitting fixation of housing 11A to a predetermined position of vehicle component 2A.

In addition, housing 11A and vehicle component 2A may be fixed to each other via a dedicated bracket (not illustrated). The dedicated bracket refers to an auxiliary component that is provided to reliably and stably fix housing 11A to vehicle component 2A. The dedicated bracket is made of a metal, a resin, or a composite material thereof. For example, the dedicated bracket may be provided with a screw hole or a groove for attaching a bolt or a nut, and a claw or a clamp portion for holding housing 11A. In addition, the dedicated bracket can be customized according to a shape or an attachment location of inner surface 22 of vehicle component 2A, and can be adapted, for example, by processing a shape or adjusting arrangement of a fixing component.

Housing 11A includes body portion 111A having an opening portion, and lid 112A that covers the opening portion and is attachable to and detachable from body portion 111A.

Body portion 111A includes a bottom portion fixed to inner surface 22 of vehicle component 2A and a side portion. The bottom portion may have a shape corresponding to a shape of inner surface 22 of vehicle component 2A.

The side portion forms a frame structure that extends in a vertical direction from the bottom portion and forms an opening portion of body portion 111A. A structure for attachably and detachably fixing lid 112A is provided on an inner surface or an outer surface of the side portion. A port for introducing a cable connected to sound pickup device 12 is provided in the side portion of body portion 111A, and the port is formed as, for example, a circular or rectangular opening portion (not illustrated).

Examples of the attachment and detachment structure between body portion 111A and lid 112A include a snap-fit, a screw, an opening portion and closing structure using a hinge, a fitting structure with a packing, and a locking structure using a clip, but the examples are not limited thereto.

In addition, the attachment and detachment structure can adopt a structure having high airtightness in order to ensure water tightness. For example, by using the packing, it is possible to prevent rainwater or moisture from entering the inside and to protect electronic components inside the housing. Further, in order to increase the water tightness, a method of adding a sealing material to a joint portion between lid 112A and body portion 111A or a method of using a rubber sealing packing in combination with a screw structure can also be adopted.

A planar shape of an outer shape of housing 11A is, for example, a rectangle illustrated in FIG. 2A, a circle, an ellipse, a polygon, or a composite shape in which a plurality of shapes are combined, but is not limited thereto.

A cross-sectional shape of the outer shape of housing 11A is, for example, a rectangle illustrated in FIG. 2B, a semicircle, a trapezoid, a triangle, an arc shape, or a composite shape in which a plurality of shapes are combined, but is not limited thereto.

A material of housing 11A is, for example, plastic, a metal, a ceramic, carbon fiber reinforced plastic (CFRP), or rubber, but is not limited thereto.

From the viewpoint of vibration, a mass of housing 11A is preferably equal to or less than a mass of vehicle component 2A. This is because, in a case where the mass exceeds the mass of vehicle component 2A, vibration characteristics transmitted to sound pickup device 12 deteriorate, and the sound pickup performance may decrease.

### Sound Pickup Device 12

Sound pickup device 12 is a device that is provided in cavity 110 in housing 11A and that is configured to recognize the outside-vehicle sound. As illustrated in FIG. 2B, an example of sound pickup device 12 is a microphone (hereinafter, referred to as a MEMS microphone) based on a micro-electro-mechanical systems (MEMS) technology, but the example is not limited thereto. Another example of sound pickup device 12 may be a device that converts air vibration into an electric signal or a vibration sensor. An example of the device that converts air vibration into an electric signal is a dynamic microphone, a piezoelectric microphone, or a capacitor-type microphone element. In addition, an example of the vibration sensor is an acceleration sensor such as a MEMS acceleration sensor or a piezo acceleration sensor, or a piezoelectric sensor using a piezoelectric element.

In addition, sound pickup device 12 is fixed to an inside of vehicle component 2A. The "inside" refers to a position on a side of vehicle component 2A opposite to outer surface 21 (surface exposed to the outside-vehicle space) and refers to an in-vehicle space or an interior space of the vehicle structure.

The MEMS microphone as sound pickup device 12 includes shield 121 having sound hole 123, vibration membrane 125, and member 124 that connects vibration membrane 125 to shield 121.

Shield 121 is a protective shield that covers the entire MEMS microphone and is configured to prevent an impact from the outside. According to FIG. 2B, shield 121 is connected to an inner bottom surface of body portion 111A of housing 11A, but may be connected to an inner side surface of body portion 111A of housing 11A or lid 112A.

Sound hole 123 is an opening portion that is configured to collect air vibration or sound waves transmitted to cavity 110 of housing 11A and to efficiently deliver the sound waves to vibration membrane 125.

Vibration membrane 125 is a core component that converts the sound waves into an electric signal and is configured to process acoustic energy.

Vibration membrane 125 is a film-shaped structure that receives vibration caused by air vibration or sound waves and that vibrates physically in response to the input of the sound. The vibration of vibration membrane 125 is converted into an electric signal.

### Detection Frequency of Sound Pickup Device 12

Sound pickup device 12 is configured to detect various sounds (for example, sounds having a frequency of 1 Hz or more and 11 kHz or less) generated around vehicle 1.

Examples of the outside-vehicle sound targeted by sound pickup device 12 include a vehicle approaching warning sound (AVAS sound). The AVAS sound is in a range of approximately 160Hz to 1,600Hz, and is, for example, a sound generated to notify a pedestrian around the vehicle of the approach of the vehicle in a case where an electric vehicle or a hybrid vehicle travels at a low speed.

In addition, the bicycle bell sound is located in a frequency band of approximately 1kHz to 3kHz. Sound pickup device 12 can detect the bicycle bell sound around vehicle 1.

Further, a human voice is in a range of approximately 85Hz to 800Hz. Sound pickup device 12 can detect a specific voice such as an outside-vehicle guidance voice or a shout.

In addition, the siren sound of the emergency vehicle is in a range of approximately 500Hz to 1,500Hz, and the approach of an ambulance, a fire engine, a police vehicle, or the like can be detected by sound pickup device 12.

In addition, the crossing gate warning sound of each country is in a range of approximately 400Hz to 2000Hz and can be detected by sound pickup device 12.

As described above, since sound pickup device 12 can detect the sound in the frequency band as described above, it is possible to accurately cover a predetermined frequency range of the sound in order to ensure safety or to understand the surrounding situation.

### Sound Insulating Material 13A

Sound insulating material 13A is a material that surrounds housing 11A and that blocks or absorbs sound. In addition, sound insulating material 13A has an opening portion that is closed by vehicle component (2A). In FIG. 2B, sound insulating material 13A is connected to inner surface 22 of vehicle component 2A at an end and has an opening portion at the end. Examples of sound insulating material 13A include silicone rubber, sound absorbing urethane foam, sound shielding sheet, and paper clay, but the examples are not limited thereto. Sound insulating material 13A is provided in order to block sound waves that are directly transmitted to housing 11A without passing through vehicle component 2A, and to cause sound pickup device 12 to pick up the sound waves via vehicle component 2A.

In addition, sound insulating material 13A surrounds sound pickup device 12 from a side opposite to vehicle component 2A. The “opposite side” refers to a direction opposite to a side on which vehicle component 2A is located, and refers to, for example, a region that is disposed on an outer peripheral surface or a rear surface of housing 11A such that a path through which sound is directly transmitted is not generated between housing 11A and the outer surface of vehicle component 2A.

Sound insulating material 13A may have a structure in which a body portion and a lid are separated from each other, as in body portion 111A and lid 112A of housing 11A. Examples of the attachment and detachment structure between the body portion and the lid of sound insulating material 13A include a snap-fit, a screw, an opening portion and closing structure using a hinge, a fitting structure with a packing, and a locking structure using a clip, but the examples are not limited thereto. As a result, it is possible to easily access the inside of cavity 110 and to smoothly perform maintenance.

In addition, sound insulating material 13A and housing 11A may be provided as an integral structure as a sound insulating housing (not illustrated). In this case, the sound insulating housing may have a structure in which a body portion and a lid are separated from each other. By integrating sound insulating material 13A and housing 11A, it is possible to simplify an assembly step and to reduce the number of components, which contributes to a reduction in manufacturing cost. In addition, by adopting the integral structure, it is possible to more easily access the inside of cavity 110, and the work efficiency of maintenance or component replacement in the inside of cavity 110 is improved. By integrating sound insulating material 13A with housing 11A, airtightness is improved, and it is possible to exhibit a higher sound insulating effect.

### Reception of Outside-vehicle Sound

The reception mechanism of the outside-vehicle sound will be described with reference to FIG. 2B. The outside-vehicle sound wave emitted from the outside-vehicle sound source reaches outer surface 21 of vehicle component 2A and is transmitted to housing 11A as vibration. On the other hand, the in-vehicle sound wave emitted from the in-vehicle sound source reaches inner surface 22 of vehicle component 2A and is transmitted to housing 11A.

In a case where the outside-vehicle sound wave reaches outer surface 21, the vibration is transmitted to housing 11A via vehicle component 2A, and sound pickup device 12 itself vibrates. Vibration membrane 125 of sound pickup device 12 vibrates due to the vibration of sound pickup device 12 itself or the vibration of air filling the cavity, and the outside-vehicle sound wave is picked up by sound pickup device 12.

Similarly, in a case where the in-vehicle sound wave reaches inner surface 22, the vibration is transmitted to housing 11A via vehicle component 2A, and sound pickup device 12 itself is shaken. Vibration membrane 125 of sound pickup device 12 vibrates due to the vibration of sound pickup device 12 itself or the vibration of air filling the cavity, and the in-vehicle sound wave is picked up by sound pickup device 12. By providing sound insulating material 13A, the in-vehicle sound wave is not directly transmitted to housing 11A.

The outside-vehicle sound wave and the in-vehicle sound wave are combined and converted into an electric signal by sound pickup device 12. The electric signal output from sound pickup device 12 is sent to another acoustic processing device, and filtering processing is performed based on frequency characteristics and amplitude characteristics of the outside-vehicle sound wave. As a result, it is possible to selectively extract, for example, a specific outside-vehicle sound (for example, an emergency vehicle sound, a crossing gate sound, a bicycle bell sound, or the like) while minimizing interference caused by the in-vehicle sound wave. In addition, the recognized outside-vehicle sound can be provided to a solution that enables integration with an advanced driver assistance system (ADAS) or the like.

According to outside-vehicle sound pickup device 10A according to Embodiment 1, the outside-vehicle sound can be efficiently picked up without directly exposing the microphone to the outside of the vehicle. Further, since housing 11A is provided as a separate component, it is possible to flexibly respond to a change in the vehicle component, and the sound pickup device or the wiring line can be easily maintained or replaced by removing the lid of the housing.

In addition, since sound pickup device 12 (for example, the MEMS microphone) mounted in housing 11A can detect the external sound in a wide frequency band, various types of alarm sounds and surrounding sounds such as a siren of an emergency vehicle, a crossing gate warning sound, and a bicycle bell sound can be picked up. In a case where the obtained signal is filtered by software, it is possible to selectively extract predetermined information after further reducing the influence of the in-vehicle sound.

In addition, by adopting the add-on attachment structure, it is possible to easily cooperate with an in-vehicle network or an advanced driver assistance system (ADAS). For example, it is expected that the scope of a safety driving support function is expanded by incorporating the external alarm sound detected by the sound pickup device into a vehicle control system.

### Variation

Outside-vehicle sound pickup device 10AA according to a variation of Embodiment 1 will be described with reference to FIG. 2C. FIG. 2C is a cross-sectional view of outside-vehicle sound pickup device 10AA according to the variation of Embodiment 1. Since vehicle component 2A, housing 11A, and sound insulating material 13A are the same as those of outside-vehicle sound pickup device 10A according to Embodiment 1, the description thereof will be omitted.

Outside-vehicle sound pickup device 10AA includes a vibration sensor as sound pickup device 12 provided in housing 11A. Examples of the vibration sensor include a piezoelectric element type sensor and an acceleration sensor, but the examples are not limited thereto. The vibration sensor as sound pickup device 12 is a device that detects mechanical vibration transmitted to housing 11A via vehicle component 2A and converts the vibration into an electric signal.

### Embodiment 2

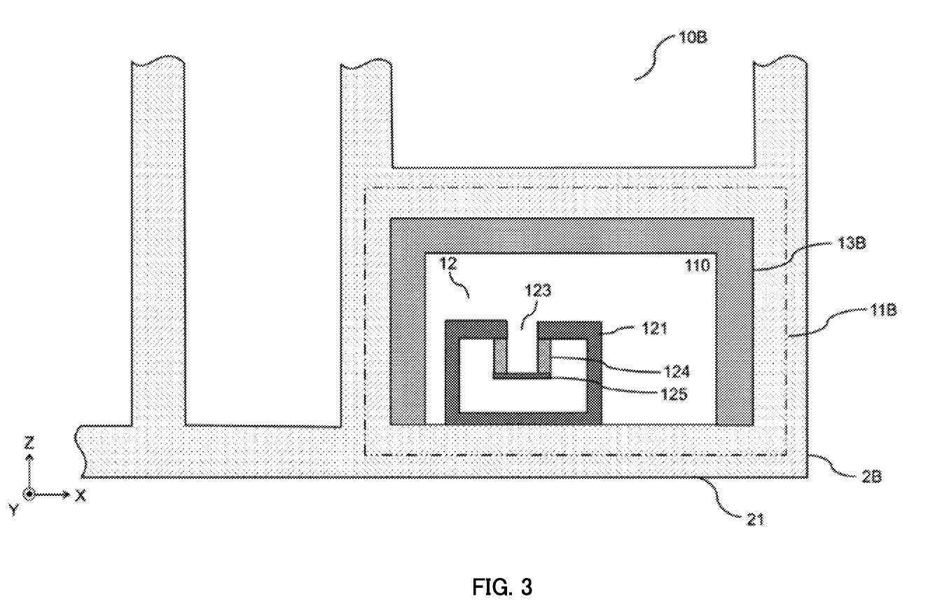

Outside-vehicle sound pickup device 10B according to Embodiment 2 will be described with reference to FIG. 3. FIG. 3 is a cross-sectional view of outside-vehicle sound pickup device 10B according to Embodiment 2. In Embodiment 2, housing 11B is integrally formed with vehicle component 2B. Outside-vehicle sound pickup device 10A according to Embodiment 1 is designed to be difficult to be integrally formed with vehicle component 2A. For example, in a case where vehicle component 2A is the windshield or the rear windshield, it is difficult to integrally manufacture housing 11A and vehicle component 2A for reasons of the complexity of the manufacturing step, the difference in material, and the like. Outside-vehicle sound pickup device 10B according to Embodiment 2 is designed to be integrally formed with vehicle component 2B in order to simplify the manufacturing step and to reduce the installation cost.

### Vehicle Component 2B

Examples of vehicle component 2B include a body of vehicle 1, a front bumper, a rear bumper, a cover of various lamps, a cover of a door mirror, a cover of a side mirror, a housing of a drive recorder, a cover of an electronic mirror, a cover of a full-circumference camera, and a drive recorder mount, but the examples are not limited thereto.

As illustrated in FIG. 3, when vehicle component 2B is the housing of the drive recorder, for example, spaces for disposing other devices having a camera function or the like are provided, and outside-vehicle sound pickup device 10B is assigned to one of the spaces. Vehicle component 2B may include an opening and closing means (not illustrated) such that sound pickup device 12 and sound insulating material 13B can be inserted.

### Outside-vehicle Sound Pickup Device 10B

Outside-vehicle sound pickup device 10B is configured to recognize the outside-vehicle sound emitted outside vehicle 1 and includes housing 11B integrally formed with vehicle component 2B and provided with cavity 110 inside, sound pickup device 12 provided in housing 11B and configured to recognize the outside-vehicle sound, and sound insulating material 13B that surrounds cavity 110.

### Housing 11B

Housing 11B is integrally formed with vehicle component 2B, and a part of a structure that defines one space formed by vehicle component 2B corresponds to housing 11B. One of surfaces of housing 11B is connected to outer surface 21 of vehicle component 2B.

### Sound Pickup Device 12

Sound pickup device 12 is the same as that of Embodiment 1, and the details thereof will be omitted.

### Sound Insulating Material 13B

Sound insulating material 13B is a material that surrounds sound pickup device 12 and that blocks or absorbs sound. In addition, sound insulating material 13B has an opening portion that is closed by vehicle component 2B. In FIG. 3, sound insulating material 13B is connected to inner surface 22 of vehicle component 2B at an end and has an opening portion at the end. Examples of sound insulating material 13B include silicone rubber, sound absorbing urethane foam, sound shielding sheet, and paper clay. Sound insulating material 13B is provided in order to block sound waves that are directly transmitted to housing 11B without passing through vehicle component 2B, and to cause sound pickup device 12 to pick up the sound waves via vehicle component 2B.

According to outside-vehicle sound pickup device 10B of Embodiment 2, housing 11B of outside-vehicle sound pickup device 10B is integrally formed with vehicle component 2B. With this configuration, a step of providing an independent housing member is not required, the manufacturing step is simplified, and the installation cost can be reduced. The reason why the manufacturing step is simplified is that, by integrally molding housing 11B with vehicle component 2B, a step of using a separate housing can be omitted, and the installation cost can be reduced. In addition, since, for example, a headlight cover or a housing of a drive recorder can be used as the vehicle component, manufacturing and design efficiency can be improved.

In addition, since outside-vehicle sound pickup device 10B is integrated with vehicle component 2B, the resistance to the external environment such as water tightness and dust proofness is improved, and outside-vehicle sound pickup device 10B can maintain highly reliable operation for a long period even under severe weather conditions.

### Embodiment 3

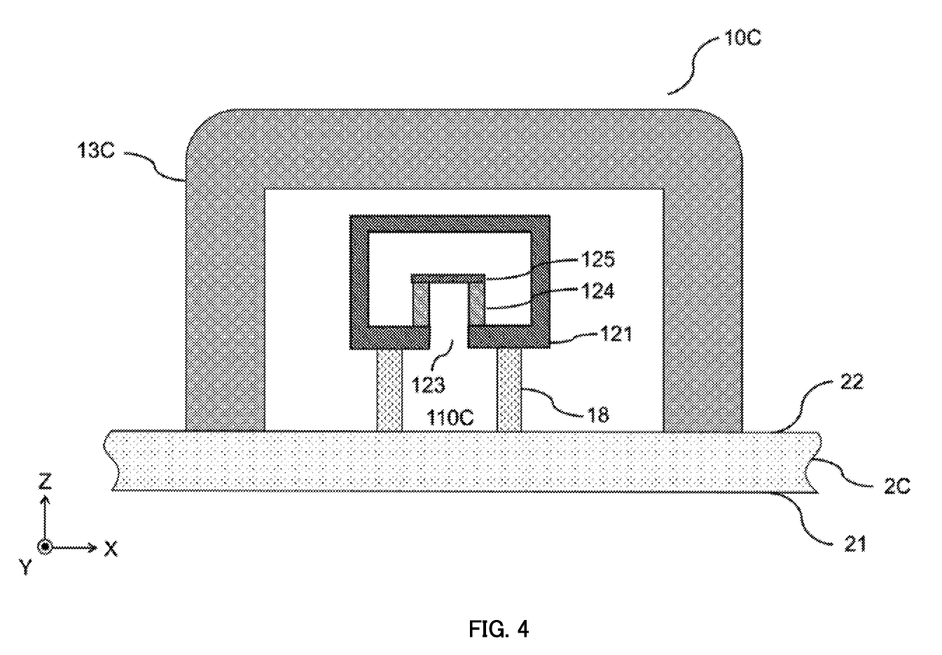

Outside-vehicle sound pickup device 10C according to Embodiment 3 will be described with reference to FIG. 4. FIG. 4 is a cross-sectional view of outside-vehicle sound pickup device 10C according to Embodiment 3.

Outside-vehicle sound pickup device 10C is mounted on vehicle component 2C of vehicle 1, is configured to pick up an outside-vehicle sound emitted outside vehicle 1, and includes ring portion 18 that is fixed to vehicle component 2C and includes cavity 110C inside, sound pickup device 12 that is mounted on ring portion 18 and that picks up the outside-vehicle sound, and sound insulating material 13C that surrounds sound pickup device 12.

### Ring Portion 18

Ring portion 18 is an annular member (ring-shaped member) that is fixed to inner surface 22 of vehicle component 2C and is configured to define cavity 110C inside. Ring portion 18 surrounds a peripheral edge of cavity 110C, forms a detection target space of air vibration by the shape, and also has a structure for supporting sound pickup device 12.

Ring portion 18 is formed of, for example, a grommet made of natural rubber or synthetic rubber, but is not limited thereto, and an appropriate elastic material is used.

An example of the shape of ring portion 18 is configured to be annular (ring-shaped). Specifically, ring portion 18 has a hollow shape having an outer peripheral portion and an inner peripheral portion such that sound pickup device 12 can be supported and cavity 110C can be defined. An outer shape of ring portion 18 is determined according to a use environment or an installation space, and is, for example, substantially circular, elliptical, or polygonal, but is not limited thereto.

A lower end surface of ring portion 18 is fixed to inner surface 22 of vehicle component 2C using an adhesive or a double-sided tape, but is not limited thereto. For example, a configuration can be adopted in which the sealing material is interposed to reduce water leakage into cavity 110C.

### Sound Pickup Device 12

Sound pickup device 12 itself is the same as that of Embodiments 1 and 2, and the detailed description thereof will be omitted. On the other hand, sound pickup device 12 is disposed such that sound hole 123 communicates with cavity 110C. As a result, vibration membrane 125 of sound pickup device 12 can capture the vibration of the air in cavity 110C.

Examples of the fixation of ring portion 18 of sound pickup device 12 to the upper end surface include an adhesive, a double-sided tape, and the like, but the examples are not limited thereto. In addition, a configuration can be adopted in which a sealing material for waterproofing is interposed between ring portion 18 and vehicle component 2C to reduce water leakage into cavity 110C.

### Sound Insulating Material 13C

Sound insulating material 13C is a material that surrounds sound pickup device 12 and that blocks or absorbs sound. In addition, sound insulating material 13C has an opening portion that is closed by vehicle component 2C. In FIG. 4, sound insulating material 13C is connected to inner surface 22 of vehicle component 2C at an end, and has an opening portion at the end.

Examples of sound insulating material 13C include silicone rubber, sound absorbing urethane foam, sound shielding sheet, and paper clay. Sound insulating material 13C is provided in order to block sound waves that are directly transmitted to ring portion 18 without passing through vehicle component 2C, and to cause sound pickup device 12 to detect the sound waves via vehicle component 2C.

According to outside-vehicle sound pickup device 10C according to Embodiment 3, the outside-vehicle sound passes through outer surface 21 of vehicle component 2C, but the direct transmission to sound pickup device 12 is suppressed by ring portion 18. Rather, the air in cavity 110C defined by sound pickup device 12, ring portion 18, and inner surface 22 of vehicle component 2C vibrates together with vehicle component 2C and shakes vibration membrane 125 of sound pickup device 12. On the other hand, the in-vehicle sound causes the air in cavity 110C to vibrate via vehicle component 2C and shakes vibration membrane 125 of sound pickup device 12. The in-vehicle sound from the in-vehicle space facing inner surface 22 and the outside-vehicle sound from the outside-vehicle space facing outer surface 21 are combined to form a composite sound of in-vehicle sound and outside-vehicle sound, which is converted into an electric signal by sound pickup device 12.

### Outside-vehicle Sound Audibility Index

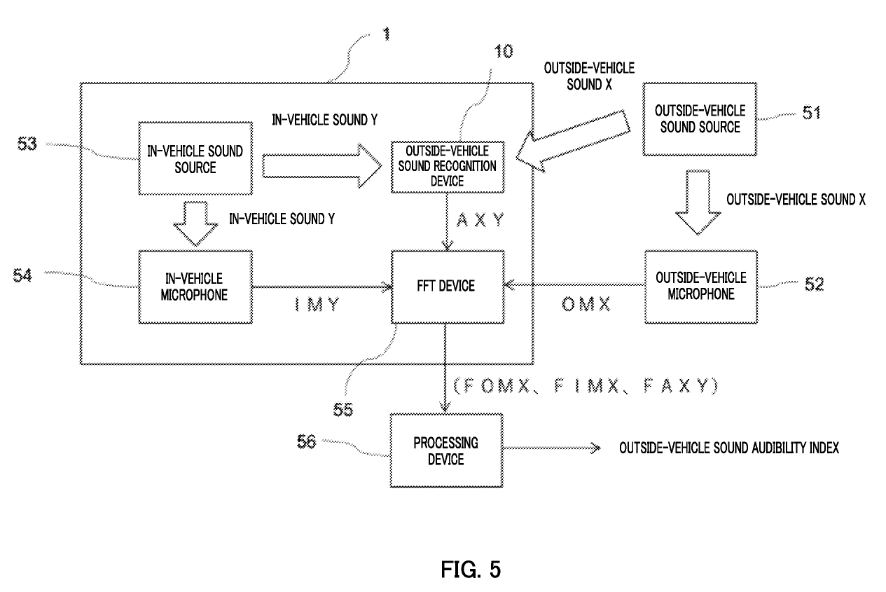

A method of obtaining an outside-vehicle sound audibility index related to outside-vehicle sound pickup device 10A according to Embodiment 1 will be described with reference to FIG. 5. FIG. 5 is a diagram showing a configuration for obtaining an outside-vehicle sound audibility index. The "outside-vehicle sound audibility index" refers to an ability to pick up the outside-vehicle sound without being disturbed by the in-vehicle sound. Specifically, the outside-vehicle sound audibility index is calculated using outside-vehicle sound pickup device 10A according to the embodiment, outside-vehicle sound source 51, outside-vehicle microphone 52, in-vehicle sound source 53, in-vehicle microphone 54, FFT device 55, and processing device 56.

Outside-vehicle sound source 51 is provided at a distance of 1m from vehicle 1 and is configured to emit outside-vehicle sound X. Outside-vehicle sound X is, for example, a sound of an emergency vehicle (corresponding to a sound pressure at a distance of about 100m).

Outdoor microphone 52 is configured to collect outside-vehicle sound X from outside-vehicle sound source 51 and output the collected sound as outside-vehicle audio signal OMX.

In-vehicle sound source 53 is provided inside vehicle 1 and is configured to emit, for example, a radio voice (frequency band of 300Hz to 3400Hz). A sound pressure level of in-vehicle sound Y is set to an average sound pressure level in a daily in-vehicle environment.

In-vehicle microphone 54 is configured to collect in-vehicle sound Y from in-vehicle sound source 53 and output the collected sound as in-vehicle audio signal IMX.

The outside-vehicle sound pickup device according to the embodiment outputs audio signal AXY in which outside-vehicle sound X and in-vehicle sound Y are superimposed.

FFT device 55 is configured to convert the input audio signal into frequency intensity (FFT). FFT device 55 converts outside-vehicle audio signal OMX into frequency intensity and outputs outside-vehicle sound frequency intensity FOMX, converts in-vehicle audio signal IMX into frequency intensity and outputs in-vehicle sound frequency intensity FIMX, and converts recognition signal AXY into frequency intensity and outputs recognition signal frequency intensity FAXY.

Processing device 56 obtains an outside-vehicle transfer function and an in-vehicle transfer function from outside-vehicle sound frequency intensity FOMX, in-vehicle sound frequency intensity FIMX, and recognition signal frequency intensity FAXY. The outside-vehicle transfer function is calculated by dividing outside-vehicle sound frequency intensity FOMX by recognition signal frequency intensity FAXY, thereby indicating how much the outside-vehicle sound is transmitted through the sound pickup device. On the other hand, the in-vehicle transfer function is calculated by dividing in-vehicle sound frequency intensity FIMX by recognition signal frequency intensity FAXY, and is an indicator for evaluating the influence degree of the in-vehicle sound. The larger the value of the outside-vehicle sound audibility index, the higher the ability to recognize the sound outside the vehicle, and the smaller the value, the lower the ability to recognize the sound outside the vehicle.

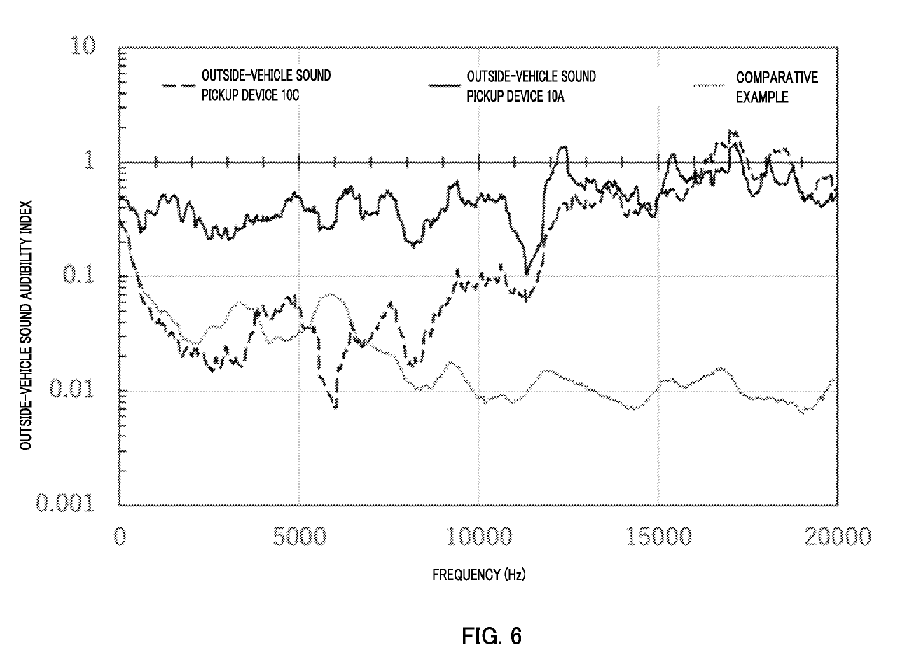

The outside-vehicle sound audibility index obtained by the configuration shown in FIG. 5 is shown in FIG. 6. FIG. 6 is a graph in which the outside-vehicle sound audibility index is plotted with respect to a frequency band (Hz). The horizontal axis (X axis) represents a frequency (Hz), and a range from 0Hz to 20,000Hz is shown. This range covers an audible frequency band for speech. The vertical axis (Y axis) represents the outside-vehicle sound audibility index on a logarithmic scale. In a case where the value of the outside-vehicle sound audibility index is 1, it means that the outside-vehicle sound and the in-vehicle sound are equal, in a case where the value is larger than 1, it means that the outside-vehicle sound is larger than the in-vehicle sound, and in a case where the value is smaller than 1, it means that the influence of the in-vehicle sound is larger than the influence of the outside-vehicle sound.

Outside-vehicle sound pickup device 10A according to Embodiment 1 generally maintains the outside-vehicle sound audibility index near 1 in a stable manner and does not fall below 0.1.

It is considered that the reason why the outside-vehicle sound audibility index of outside-vehicle sound pickup device 10C according to Embodiment 3 is decreased in a low frequency band (around 0 to 10,000Hz) is that the influence of the in-vehicle sound is large in the low frequency characteristics. On the other hand, in a high frequency band of 10,000Hz or more, the outside-vehicle sound tends to be sufficiently emphasized by the sound pickup device.

In the comparative example corresponding to the existing microphone provided in vehicle 1, the outside-vehicle sound audibility index is generally lower than 0.1 and is lower than that of outside-vehicle sound pickup device 10A according to Embodiment 1.

From these experimental results, it was clarified that outside-vehicle sound pickup device 10A according to Embodiment 1 has a stable outside-vehicle sound audibility index in a wide frequency band and does not fall below 0.1 even in a low frequency band (0 to 20,000Hz) and has a performance of efficiently picking up the outside-vehicle sound. On the other hand, it is shown that outside-vehicle sound pickup device 10C according to Embodiment 3 tends to have a decrease in a part of the performance in the low frequency band but shows the same sound pickup performance as that of Embodiment 1 in the high frequency band exceeding 10,000Hz, and is useful for an application that emphasizes a specific frequency band.

In addition, it is confirmed that the outside-vehicle sound pickup device in the comparative example has a low overall outside-vehicle sound audibility index, and a wide range of regions where the outside-vehicle sound audibility index is lower than 0.1, and is greatly affected by the in-vehicle sound. From this, it is shown that it is difficult to accurately pick up the outside-vehicle sound in the existing microphone of the existing in-vehicle installation type.

Based on the above results, it is shown that the outside-vehicle sound pickup device according to the present disclosure has a significantly improved sound pickup performance of the outside-vehicle sound as compared with the existing in-vehicle installed existing microphone, and it is likely that the collection of information on the outside-vehicle sound can contribute to the improvement of the driver assistance system and the safety function.

The outside-vehicle sound acquired by the sound pickup device according to the present embodiment can be used as useful information by being associated with various functions in the vehicle system.

### Detection of Emergency Vehicle or Alarm Sound

The siren sound of an ambulance, a fire engine, a patrol car, the crossing gate warning sound, the bicycle bell sound, and the like are detected to early alert the driver. As a result, it is possible to cooperate with an advanced driver assistance system (ADAS) such as automatic braking control of the vehicle or warning display.

### Surrounding Surveillance

The voice of a pedestrian or the noise level around is detected to notify the driver of the risk of hiding in a blind spot. By combining with voice analysis, it can be applied to a high-level safety function such as raising an alert to the driver or the system in a case where a specific word ("help", "help me", or the like) is detected.

### Use for Driving Comfort or Sound Environment Control

The noise outside the vehicle is understood in real time to optimize the control of in-vehicle acoustic systems or active noise cancellation devices. For example, the predetermined external information can be introduced into the vehicle for the driver and used for smart cabin control such as reducing the noise.

### Emergency Recording/Evidence Recording Function

In a case where a collision or an abnormal sound occurs outside the vehicle during traveling or parking, the voice is recorded in synchronization with the drive recorder system. It makes it possible to verify the video and the voice, which is useful for post-incident trouble analysis and insurance response.

### Cooperation with Autonomous Driving or V2X System

A warning sound or a vehicle approaching sound emitted from the surroundings is integrated with other sensor information (camera, radar, LiDAR, or the like) to perform a comprehensive risk determination. It is possible to realize an advanced traffic management or a safe driving support function in cooperation with other vehicles or infrastructure.

### Combination with Voice UI

A voice guide or an announcement (for example, an automatic door announcement or information provision to a pedestrian such as "This vehicle will turn right") is controlled by cooperation with an outside-vehicle speaker to control. A system in which the in-vehicle voice assistant automatically responds to a call from the outside or the driver remotely responds can also be considered.

As described above, the outside-vehicle sound picked up in the present embodiment can be used in a multi-faceted manner by improving safety and comfort through the understanding of the alarm sound of the emergency vehicle or the surrounding environmental sound, and by being integrated into various functions of the vehicle such as the drive recorder or the autonomous driving system. With such an integrated application, it is expected to contribute to reducing the risk during traveling, improving the convenience and peace of mind of the user, and realizing advanced driving support.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No.2025-020019, filed on February 10, 2025, the disclosure of which including the specification, drawings and abstract is incorporated herein by reference in its entirety.

### INDUSTRIAL APPLICABILITY

The present disclosure is widely available for an outside-vehicle sound pickup device.

1. An outside-vehicle sound pickup device, comprising:
a sound pickup device; and
a sound insulating material shaped to have a space on which the sound pickup device is configured to be mounted, wherein
the sound insulating material has an opening portion that is closed by a vehicle component.

2. The outside-vehicle sound pickup device according to claim 1, wherein
the sound pickup device which, in operation, picks up an outside-vehicle sound.

3. The outside-vehicle sound pickup device according to claim 1, further comprising:
a housing that accommodates the sound pickup device inside.

4. The outside-vehicle sound pickup device according to claim 1, wherein
the sound pickup device is a MEMS microphone.

5. The outside-vehicle sound pickup device according to claim 1, wherein
the sound pickup device is a vibration sensor.

6. The outside-vehicle sound pickup device according to claim 1, wherein
the sound pickup device has a sound hole that communicates with the space formed by the sound insulating material.

7. The outside-vehicle sound pickup device according to claim 1, wherein
in a case where the vehicle component is configured to be mounted on an opened space, the sound insulating material surrounds a housing fixed to the vehicle component.

8. The outside-vehicle sound pickup device according to claim 1, wherein
in a case where the vehicle component has a closed space, the sound insulating material surrounds an interior of the closed space of the vehicle component.

9. The outside-vehicle sound pickup device according to claim 1, wherein
the sound pickup device is fixed to an inside of the vehicle component by an annular member, and
the sound pickup device has a sound hole that is open to face the annular member and that communicates with a cavity inside the annular member.

10. The outside-vehicle sound pickup device according to claim 9, wherein
the annular member is a member that is provided integrally with the vehicle component.

11. A vehicle, comprising:
the outside-vehicle sound pickup device according to claim 1.

12. An outside-vehicle sound detection method, comprising:
picking up an outside-vehicle sound by a sound pickup device surrounded by a sound insulating material having an opening portion that is closed by a vehicle component, the outside-vehicle sound being a sound emitted outside a vehicle; and
detecting a situation outside the vehicle based on the outside-vehicle sound.
